(19) United States
(12) Patent Application Publication
(10) Pub. No.: US 2001/0055253 A1
(43) Pub. Date: Dec. 27, 2001

(54) Audio appliance for playing back compressed and uncompressed audio files

(75) Inventor: Jean-Marc Bresit, Rambouillet (FR)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann VDO AG

(21) Appl. No.: 09/887,431

(22) Filed: Jun. 22, 2001

(30) Foreign Application Priority Data
Jun. 23, 2000 (DE) 100 30 841.4

(51) Int. Cl. G11B 7/00

(52) U.S. Cl. 369/47.41; 369/59.21

(57) ABSTRACT

The invention relates to an audio appliance, such as a CD or DVD player. To read and reproduce both compressed and uncompressed audio data on such an audio appliance in real time without buffer-storage, the audio appliance is designed such that the rotation speed of the storage medium may be set on the basis of the type of audio data which are to be read.

### BACKGROUND OF THE INVENTION

1. Field of the Invention

The present invention relates to an audio appliance for reading and processing digital audio data stored on an optical storage medium and having a controlled drive device which sets the storage medium in rotation and varies the speed of rotation, optical sampling means for reading the audio data from the storage medium, a decompression module for compressed audio data which receives the read audio data from the optical sampling system, and evaluation means for evaluating the digital audio data.

2. Description of the Related Art

An audio appliance is disclosed in WO 99/28902 that is used for playing back compressed audio files. The audio data is stored on the storage medium using a variable bit rate. In addition, a speed profile is stored on the storage medium. When the audio data are read, the rotation speed of the drive device is controlled by this speed profile.

Other audio appliances for reproducing uncompressed audio data operate at a fixed bit rate. For the additional reproduction of compressed audio data, these appliances contain a decompression module and a sufficiently large memory for buffer-storing the audio data. In these appliances, uncompressed audio data may be reproduced in real time. However, when reproducing compressed audio data, which have a higher information content than the uncompressed audio data, it is necessary to buffer-store the compressed audio data when the reading speed is constant.

### SUMMARY OF THE INVENTION

It is an object of the invention to provide an audio appliance for reproducing both compressed and uncompressed audio data which has a simplified design over the prior art.

The object is met by an audio appliance of the generic type for reading compressed and uncompressed audio data from the storage medium being designed such that the rotation speed may be varied on the basis of the type of audio data that are to be read. In an embodiment of the present invention, the audio appliance includes a device for setting different rotation speeds for the storage medium, wherein different rotation speeds are chosen for reading compressed and uncompressed audio data. In such an embodiment, the reading rate for the audio data is therefore generally lower when reading compressed data than when reading uncompressed data. Such matching of the rotation speed to the type of audio data which are to be read and hence to the information density of the audio data makes it possible to achieve real-time reproduction both for compressed and uncompressed audio data without buffer-storage of the audio data which are read. Accordingly, the buffer memory which is otherwise necessary may be dispensed with completely or may at least be designed to have a lower storage capacity than in the prior art.

The rotation speed for compressed and uncompressed audio data may be set manually using keys on the audio appliance itself. For this purpose, an embodiment may include a key which reduces the rotation speed of the drive device. The key is pressed to reproduce compressed audio data. It is preferable, however, for this changeover in rotational speed to occur automatically. An automatic changeover may be achieved by deriving the type of audio data stored from information stored on the storage medium. For example, corresponding information is stored in a ‘header’ on the storage medium in a known manner. If the audio appliance detects that compressed data need to be read from the storage medium, the rotation speed of the drive device is automatically reduced. If, however, the audio appliance detects that uncompressed audio data need to be read, a higher rotation speed is set and the decompression module is automatically bypassed.

The audio data stored on the storage medium may, in particular, be lossy-compressed and/or asymmetrically compressed audio data. Compression methods corresponding this type of data are sufficiently well known. In particular, the compressed audio data may be audio data compressed on the basis of the MP3 standard. With lossy compression of data, information is lost, but the degree of compression is much higher than in the case of loss-free compression. With symmetrical compression algorithms, the amount of time and computation required are the same for compression and decompression, whereas, in the case of the preferred asymmetrical methods, creating the compressed data takes much longer than decompression. Furthermore, an advantage of asymmetrical compression is that very high compression rates can be achieved.

MP3 denotes an ISO standardized method for compression of audio data. MP3 is a ‘psycho-acoustic’ method, in which inaudible parts of a piece of music are removed to reduce the volume of data. MP3 is an asymmetrical, lossy compression method. Up to a compression of 1 to 12, the quality of MP3 files is still at CD level. Accordingly, a conventional CD is able to store digital audio data with a music playing time of approximately 15 hours using compression with the MP3 method.

Besides the use of a CD as storage medium, the use of a DVD as storage medium is particularly preferred. The DVD has a storage capacity of up to 25 times greater than that of the CD.

A storage medium may hold both compressed and uncompressed audio data. An appropriate item of information in the header of each piece of music may be used by the audio appliance to automatically detect whether compressed or uncompressed audio data need to be read. The rotation speed of the storage element may then be set in accordance with the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a block diagram of an audio appliance according to a first embodiment of the present invention; and

FIG. 2 is a block diagram of an audio appliance according to a second embodiment of the present invention.

### DETAILED DESCRIPTION OF THE PRESENTLY PREFERRED EMBODIMENTS

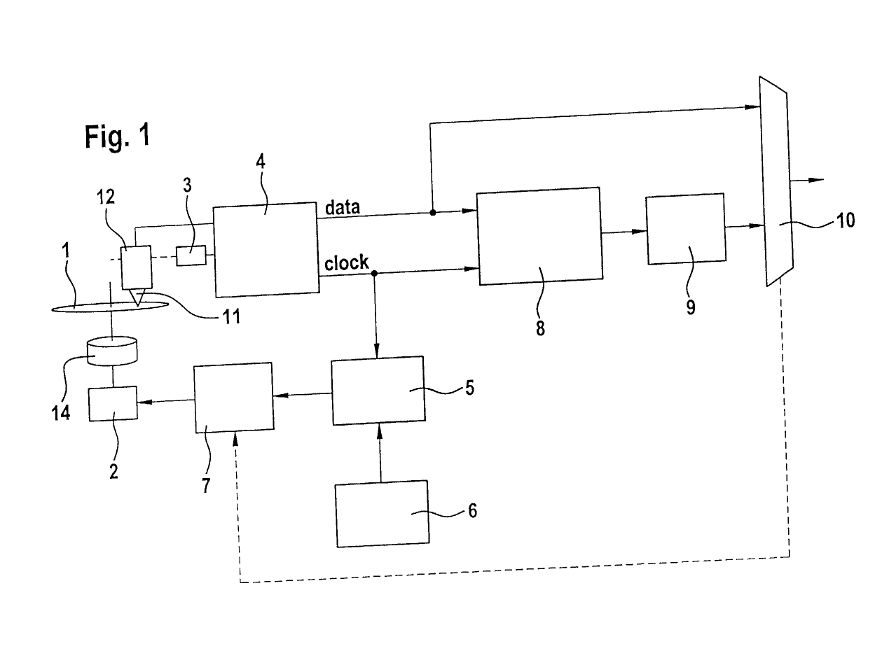

FIG. 1 is a block diagram of an audio appliance according to an embodiment of the present invention. The audio appliance is shown as a CD player and has the familiar design of commercially available appliances in many respects. A storage medium 1 such as, for example, a CD, a CD-ROM or a DVD is set into a rotational movement by a drive device 2 of the audio appliance having a rotary motor 14. The rotational movement causes the storage medium 1 to pass by an optical sampling unit 12 having a read head 11 which contains a laser unit for scanning the surface of the storage medium 1. The sampling unit 12 with the read head 11 is connected to an adjusting device 3 arranged such that the sampling unit 12 is movable relative to the storage medium 1 by the adjusting device 3. The entire surface of the storage medium that is provided with data contents may be optically scanned by the rotation of the storage medium 1 and linear movement of the sampling unit 12. The sampling unit 12 outputs signals in response to the data scanned which are transmitted to an extraction module 4 which extracts the data and an associated clock signal on the storage medium 1. The clock signal is also transmitted to a phase comparison unit 5 which simultaneously receives further signals from a clock generator 6. The clock generator 6 is designed to produce clock signals at frequencies of 32 kHz, 44.1 kHz and 48 kHz. The phase comparison unit 5 ascertains a phase difference between the clock signal determined from the audio data and the clock signal supplied by the clock generator 6.

The phase difference which the phase comparison unit 5 ascertains is transmitted to a monitoring unit 7 for controlling the drive unit 2 which contains the rotary motor 14, thereby controlling the rotational speed of the storage medium 1. In addition to keeping the rotation speed constant in a known manner, the present invention allows the storage medium 1 to be rotated at different rotation speeds. More specifically, the rotational speed may be varied on the basis of whether the data which are read are compressed or uncompressed audio data. By way of example, the rotation speed may be set by pulse width modulation (PWM) of the drive signal. However, any other known means for adjusting rotation speed may also be used.

The rotation speed of the storage medium 1 determines the data rate that data is scanned by the sampling unit 12. By matching the rotation speed of the storage medium 1 to the type of data which are read, the audio data extracted by the extraction module 4 may be supplied directly to a block decoder 8 without buffer-storage even when the audio data is compressed audio data. Accordingly, the requirement for a memory element for buffer-storing the data is obviated by the present invention because the data are provided on the basis of the data rate which is necessary for real-time reproduction.

The block decoder 8 corrects erroneous data. The corrected audio data are then supplied to a decompression module 9 where the audio data are decompressed in a known manner. The decompressed data are then transmitted to evaluation means 10 which, in particular, contain a digital/analog conversion element and various amplification stages. The analog audio signals may then be reproduced via loudspeakers or headphones in a known manner. The data output by the extraction module 4 are also supplied directly to a further input of the evaluation means 10, thereby allowing the block decoder 8 and the decompression module 9 to be bypassed when the audio data being read are uncompressed audio data. In this embodiment, the decision as to whether the audio data supplied directly to the evaluation means 10 by the extraction module 4 are uncompressed audio data will be made in the evaluation means 10 themselves. The evaluation means 10 may optionally route a signal to the monitoring unit 7 of the drive device 2, which signal sets the rotation speed on the basis of the type of data which are read.

One of the ways to determine whether the storage medium 1 is an audio CD with an uncompressed content or a CD-ROM with compressed data includes evaluating the first sectors of the storage medium 1. These first sectors are filled with “zero” when the storage medium is a CD-ROM. If, by contrast, data are found in these sectors, then these are a “table of contents” (TOC), in particular, which means that the storage medium is an audio CD.

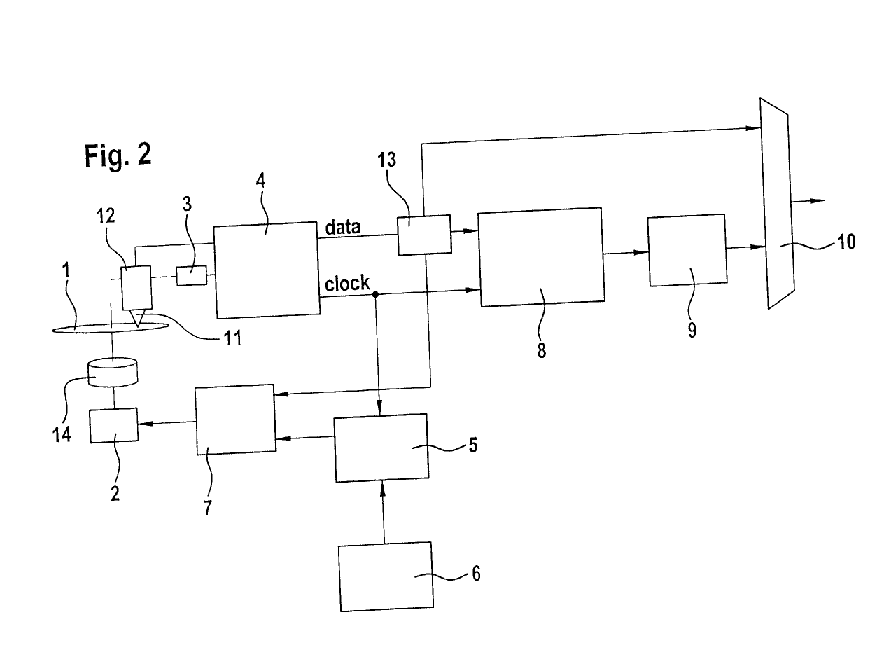

FIG. 2 shows an alternative embodiment in which a decision module 13 is incorporated in the data line between the extraction module 4 and the block decoder 8. The decision module 13 determines whether the incoming data are compressed or uncompressed audio data. In this context, the determination may include evaluating the header information at the front of each audio file. In particular, this determination may also be made in a microprocessor of the audio appliance, so that the decision module 13 is at least partly integrated in such a microprocessor in the form of a program. On the basis of the result of this determination, the audio data are then supplied directly either to the block decoder 8 or to the evaluation means 10 by an appropriate switching element arranged in the decision module 13. The decision module 13 also routes a signal to the monitoring unit 7 of the drive device 2, said signal setting the rotation speed of the drive device 2 and hence of the storage medium 1 on the basis of the type of audio data which are to be read.

The variation of the rotation speed on the basis of the type of audio data present on the storage medium according to the present invention allows any type of data on the storage medium to be read in real time. That is, the data need not be buffered, even when the data comprises compressed data. The present invention also allows the speed of the rotary motor 14 and of the adjusting device 3 to be reduced. This results in a reduction in costs, power consumption and problems associated with electromagnetic compatibility (EMC/EMI). Furthermore, the active operating phases of the laser diode in the read head 11 in the present invention are reduced compared with the prior art. This reduces the operating temperature of the laser diode and increases the reliability thereof.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An audio appliance for reading and processing digital audio data stored on an optical storage medium, comprising:
a controlled drive device arranged for rotating the storage medium at a speed of rotation that is variable;
optical sampling means for reading the audio data from the storage medium;
a decompression module operatively connected to said optical sampling means for receiving the audio data read by said optical sampling means and for decompressing compressed audio data; and
evaluation means for converting the digital audio data to analog audio data,
wherein said speed of rotation is varied in response to a type of audio data being read by said optical sampling means.

2. The audio appliance of claim 1, wherein said speed of rotation is set to a first speed when the audio data read by said optical sampling means comprises compressed data and said speed of rotation is set to a second speed when the audio data read by said optical sampling means comprises uncompressed data, said first speed being lower than said second speed.

3. The audio appliance of claim 1, further comprising means for automatically bypassing said decompression module when the audio data read by said optical sampling means comprises uncompressed audio data.

4. The audio appliance of claim 1, wherein said speed of rotation is automatically settable for a continuous audio reproduction without buffering of the audio data when the audio data read by said optical sampling means comprises compressed data and when the audio data read by said optical sampling means comprises uncompressed data.

5. The audio appliance of claim 1, wherein said decompression module is arranged for decompressing lossy-compressed audio data.

6. The audio appliance of claim 1, wherein said decompression module is arranged for decompressing asymmetrically compressed audio data.

7. The audio appliance of claim 1, wherein said decompression module is designed on the basis of the MP3 standard.

8. The audio appliance of claim 1, wherein said speed of rotation is automatically determined from information stored on the storage medium.

9. The audio appliance of claim 1, wherein the storage medium is a compact disk.

10. The audio appliance of claim 1, wherein the storage medium is a digital versatile disk.

11. The audio appliance of claim 1, wherein the storage medium contains both compressed and uncompressed audio data.
